(19) United States
(12) Patent Application Publication
(10) Pub. No.: US 2012/0085476 A1
(43) Pub. Date: Apr. 12, 2012

(54) PNEUMATIC TIRE WITH A WOVEN OR KNITTED BEAD REINFORCEMENT

(76) Inventors: Yves Donckels, Natoye (BE); Serge Julien Auguste Imhoff, Schrondweiler (LU)

(21) Appl. No.: 12/899,727

(22) Filed: Oct. 7, 2010

(51) Int. Cl. B60C 9/11; B60C 9/02

(52) U.S. Cl. 152/556; 152/563; 152/557

(57) ABSTRACT

A pneumatic tire has an axis of rotation. The pneumatic tire includes a carcass having at least one reinforced ply and a reinforcing structure proximal to a bead region of the pneumatic tire, a tread disposed radially outward of the carcass, and a belt structure disposed radially between the carcass and the tread. The reinforcing structure includes at least one layer of an open construction woven or knitted fabric having warp yarns extending in a circumferential direction and weft yarns of the carcass ply extending in a radial direction.

### FIELD OF THE INVENTION

The present invention relates to a pneumatic tire, and more particularly, to a low rolling resistance pneumatic tire.

### BACKGROUND OF THE INVENTION

A pneumatic tire typically includes a pair of axially separated inextensible beads. A circumferentially disposed bead filler apex extends radially outward from each respective bead. At least one carcass ply extends between the two beads. The carcass ply has axially opposite end portions, each of which is turned up around a respective bead and secured thereto. Tread rubber and sidewall rubber is located axially and radially outward, respectively, of the carcass ply.

The bead area is one part of the tire that contributes a substantial amount to the rolling resistance of the tire, due to cyclical flexure which also leads to heat buildup. Under conditions of severe operation, as with runflat and high performance tires, the flexure and heating in the bead region can be especially problematic, leading to separation of mutually adjacent components that have disparate properties, such as the respective moduli of elasticity. In particular, the ply turnup ends may be prone to separation from adjacent structural elements of the tire.

A conventional ply may be reinforced with materials such as nylon, polyester, rayon, and/or metal, which have much greater stiffness (i.e., modulus of elasticity) than the adjacent rubber compounds of which the bulk of the tire is made. The difference in elastic modulus of mutually adjacent tire elements may lead to separation when the tire is stressed and deformed during use.

A variety of structural design approaches have been used to control separation of tire elements in the bead regions of a tire. For example, one method has been to provide a “flipper” surrounding the bead and the bead filler. The flipper works as a spacer that keeps the ply from making direct contact with the inextensible beads, allowing some degree of relative motion between the ply, where it turns upward under the bead, and the respective beads. In this role as a spacer, a flipper may reduce disparities of strain on the ply and on the adjacent rubber components of the tire (e.g., the filler apex, the sidewall rubber, in the bead region, and the elastomeric portions of the ply itself).

The flipper may be made of a square woven fabric that is a textile in which each fiber, thread, or cord has a generally round cross-section. When a flipper is cured with a tire, the stiffness of the fibers/cords becomes essentially the same in any direction within the plane of the textile flipper.

In addition to the use of flippers as a means by which to reduce the tendency of a ply to separate, or as an alternative, another method that has been used involves the placement of “chippers.” A chipper is a circumferentially deployed metal or fabric layer that is disposed within the bead region in the portion of the tire where the bead fits onto the wheel rim. More specifically, the chipper lies inward of the wheel rim (i.e., toward the bead) and outward (i.e., radially outward, relative to the bead viewed in cross section) of the portion of the ply that turns upward around the bead. Chippers serve to stiffen, and increase the resistance to flexure of, the adjacent rubber material, which itself is typically adjacent to the turnup ply endings.

### SUMMARY OF THE INVENTION

A pneumatic tire in accordance with the present invention has an axis of rotation. The pneumatic tire includes a carcass having at least one reinforced ply and a reinforcing structure proximal to a bead region of the pneumatic tire, a tread disposed radially outward of the carcass, and a belt structure disposed radially between the carcass and the tread. The reinforcing structure includes at least one layer of an open construction woven or knitted fabric having warp yarns extending in a circumferential direction and weft yarns of the carcass ply extending in a radial direction.

In one aspect of the present invention, the woven fabric has a 5 EPI to 18 EPI warp pair construction and a 5 EPI to 35 EPI weft construction

In another aspect of the present invention, the warp yarns are 1220/1 Dtex rayon and the weft yarns are 1840/2 Dtex rayon or 2200/2 Dtex polyester constructions. Other examples of constructions to be used as weft may be: 1100/2, 1440/2, 1670/2, 2200/2 Dtex polyester or 220/2, 1840/2, 1840/3, 2440/2 Dtex rayon.

In still another aspect of the present invention, the warp yarns have a density of 18 EPI and the weft yarns have a density of 12 EPI.

In still another aspect of the present invention, the fabric has a LENO 2T or knitted configuration with a 5 EPI to 18 EPI warp pair construction and a 5 EPI to 35 EPI weft construction.

In yet another aspect of the present invention, the warp yarns have a density of 14 EPI and the weft yarns have a density of 26 EPI.

In still another aspect of the present invention, the pneumatic tire is a high performance tire.

In yet another aspect of the present invention, the woven fabric further comprises an adhesion promoter disposed thereon.

In still another aspect of the present invention, the reinforcing structure of the carcass has one or more layers of woven or knitted fabric.

In yet another aspect of the present invention, the warp yarns comprise at least two fibers of different fiber materials.

### DEFINITIONS

“Apex” means an elastomeric filler located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Denier” means the weight in grams per 9000 meters (unit for expressing linear density).

“Dtex” means the weight in grams per 10,000 meters.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“High Tensile Steel (HT)” means a carbon steel with a tensile strength of at least 3400 MPa @ 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Knitted” means intertwining threads in a series of connected loops. For example, knitted may define a method by which thread or yarn is turned into a fabric of consecutive loops, called stitches. As each row of stitches progresses, a new loop may be pulled through an existing loop.

“LASE” is load at specified elongation.

“Lateral” means an axial direction.

“Lay length” means the distance at which a twisted filament or strand travels to make a 360 degree rotation about another filament or strand.

“Mega Tensile Steel (MT)” means a carbon steel with a tensile strength of at least 4500 MPa @ 0.20 mm filament diameter.

“Normal Load” means the specific design inflation pressure and load assigned by the appropriate standards organization for the service condition for the tire.

“Normal Tensile Steel (NT)” means a carbon steel with a tensile strength of at least 2800 MPa @ 0.20 mm filament diameter.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Super Tensile Steel (ST)” means a carbon steel with a tensile strength of at least 3650 MPa @ 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa @ 0.20 mm filament diameter.

“Woven” means interlacing lengthwise yarns (warp) with filling yarns (weft). The interlaced yarns may be two or more sets of yarns at right angles to each other.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### BRIEF DESCRIPTION OF THE DRAWINGS

The structure, operation, and advantages of the present invention will become more apparent upon contemplation of the following description as viewed in conjunction with the accompanying drawings, wherein:

FIG. 1 represents a schematic cross-sectional view of an example tire for use with the present invention;

FIG. 2 represents a schematic detail view of the bead region of the example tire shown in FIG. 1;

FIG. 3 represents a schematic detail view of a section of carcass ply in accordance with the present invention;

FIG. 4 represents a schematic detail of an example bead fabric structure in accordance with the present invention; and

FIG. 5 represents a schematic detail of another example bead fabric structure in accordance with the present invention.

### DETAILED DESCRIPTION OF AN EXAMPLE EMBODIMENT

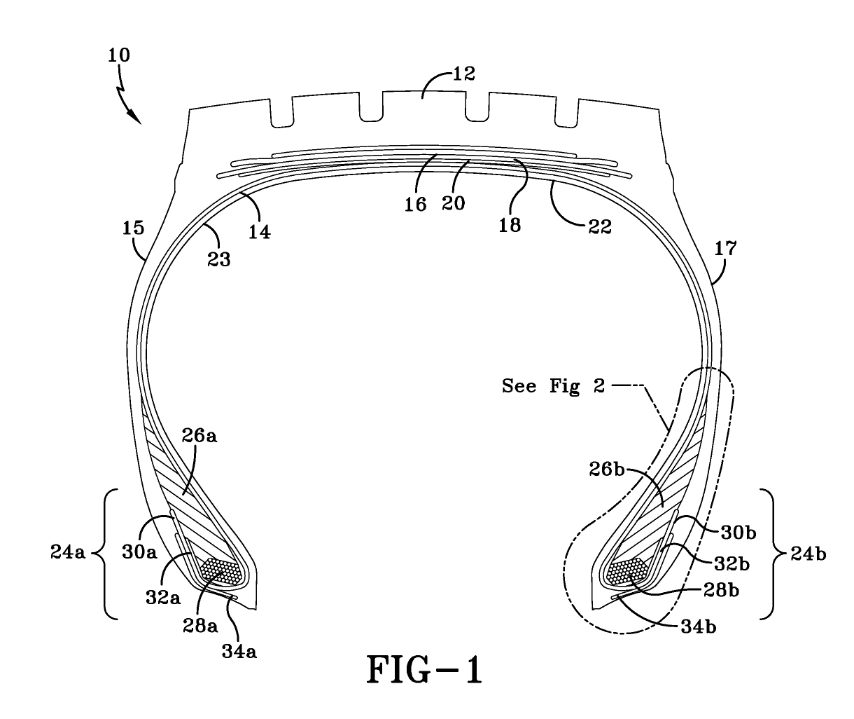

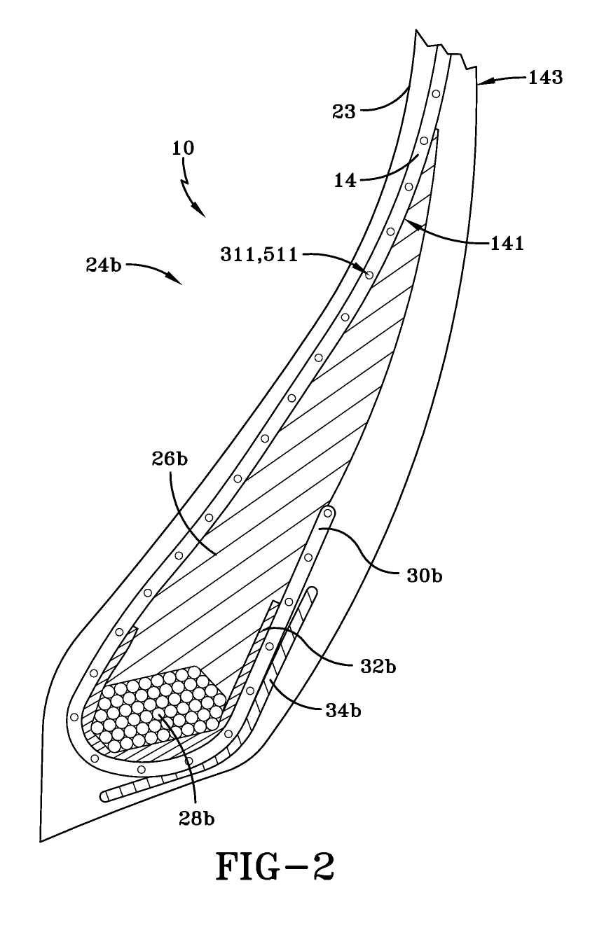

FIG. 1 shows an example tire 10 for use with the present invention. The example tire 10 has a tread 12, an innerliner 23, a belt structure 16 comprising belts 18, 20, a carcass 22 with a single carcass ply 14, two sidewalls 15,17, and two bead regions 24a, 24b comprising bead filler apexes 26a, 26b and beads 28a, 28b. The example tire 10 is suitable, for example, for mounting on a rim of a passenger vehicle. The carcass ply 14 includes a pair of axially opposite end portions 30a, 30b, each of which is secured to a respective one of the beads 28a, 28b. Each axial end portion 30a or 30b of the carcass ply 14 is turned up and around the respective bead 28a, 28b to a position sufficient to anchor each axial end portion 30a, 30b, as seen in detail in FIG. 2.

The carcass ply 14 may be a rubberized ply having a plurality of substantially parallel carcass reinforcing members made of such material as polyester, rayon, or similar suitable organic polymeric compounds. The carcass ply 14 may engage the axial outer surfaces of two flippers 32a, 32b and two chippers 34a, 34b.

In accordance with the present invention, the bead regions 24a, 24b may be further reinforced with a woven reinforcing structure 141. The woven reinforcing structure 141 may comprise the parallel carcass reinforcing members (weft) 312, 512 of the carcass ply 14 within the bead regions 24a, 24b and additional reinforcement members (warp) 311, 511 for further reinforcing the bead regions and thereby reducing rolling resistance of the pneumatic tire 10.

One woven reinforcing structure 141 may define a layer of LENO weave fabric disposed around the beads 28a, 28b in the bead regions 24a, 24b. The woven reinforcing structure 141 reinforces the bead regions 24a, 24b and stabilizes the radially inwardmost part of the sidewalls 15, 17.

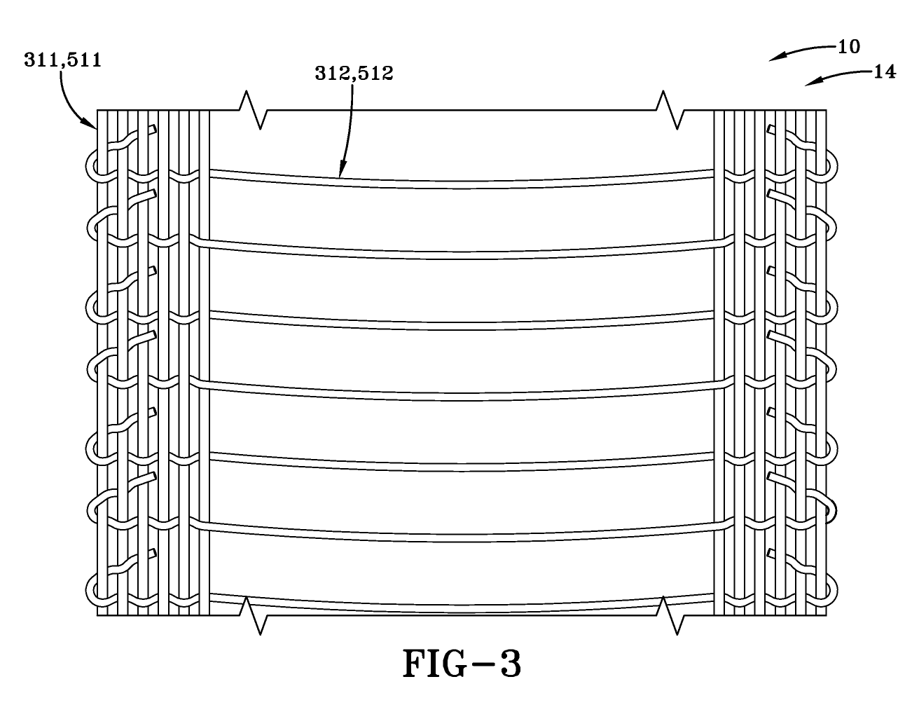

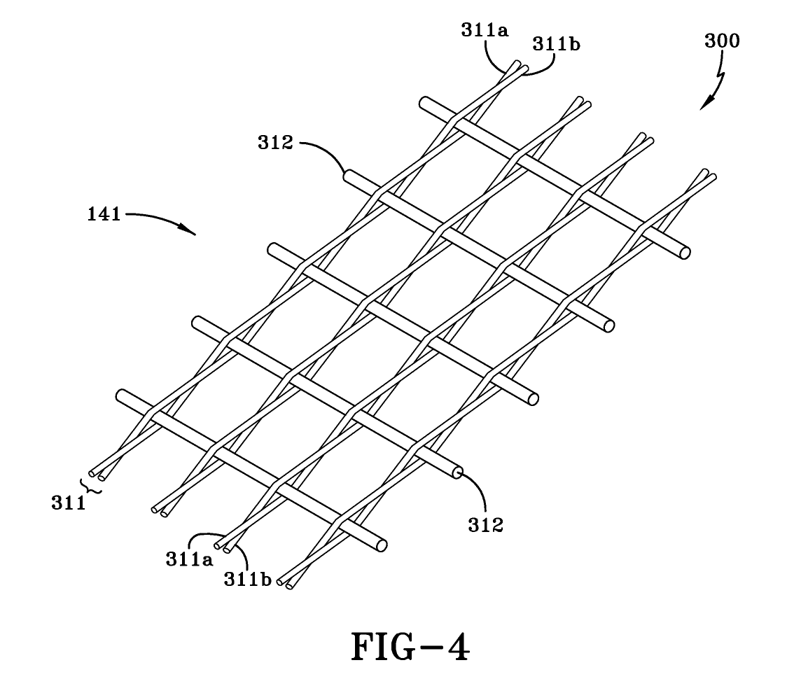

As illustrated in the example of FIGS. 3 and 4, a woven reinforcing structure 141 may comprise a layer or layers 300 of LENO fabric 310 with warp yarn pairs 311 extending generally in a circumferential direction of the pneumatic tire 10 and weft yarns 312 from the carcass ply 14 extending generally in a radial direction of the pneumatic tire. Each warp yarn pair 311 may have warp yarns 311a and 311b twisting around each other between fill weft yarns 312.

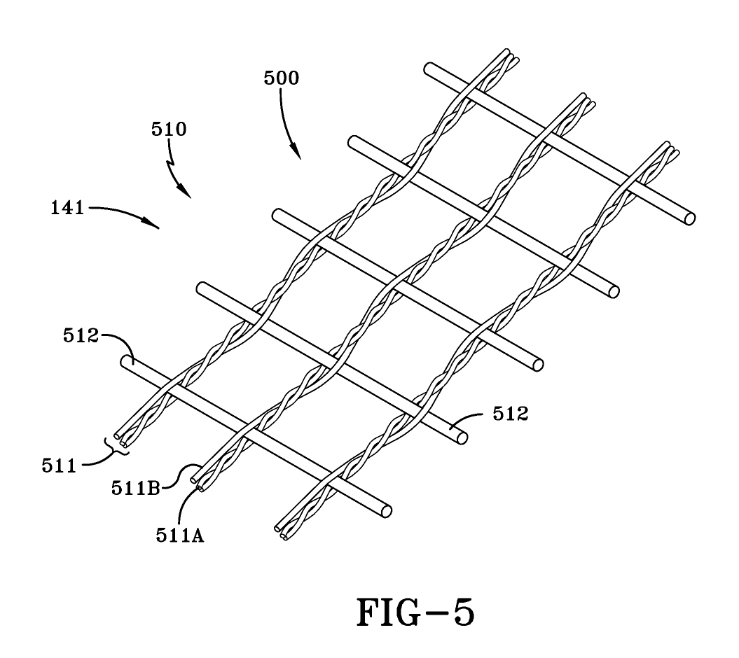

As illustrated alternatively in the example of FIGS. 3 and 5, the woven reinforcing structure 141 may comprise a layer or layers 500 of LENO 2T fabric 510 with warp yarns 511 extending generally in a circumferential direction of the pneumatic tire 10 and weft yarns 512 from the carcass ply 14 extending generally in the radial direction of the pneumatic tire. Each warp yarn 511 may have a first set of twisted pairs of filler warp yarns 511a extending on one side of, and perpendicular to, fill weft yarns 512 and a second set of warp yarns 511b extending generally parallel to and below the filler warp yarns 511a and alternating above/below the weft yarns 512.

As seen in FIGS. 2 and 4, the warp yarn pairs 311 extend circumferentially along the LENO fabric 310. It is the warp yarns 311a and 311b that provide the reinforcement of the bead regions 24a, 24b. The construction, material, size, and spacing of the warp yarns 311a, 311b are selected such that they provide reinforcement for optimum rolling resistance. The warp yarns 311a, 311b may be a spun staple yarn, a multifilament yarn, and/or a monofilament yarn formed of a suitable material.

Examples of suitable materials for the warp yarns 311a, 311b include polyamide, aramids (including meta and para forms), polyester, polyvinyl acetate, nylon (including nylon 6, nylon 6,6, and nylon 4,6), polyethylene naphthalate (PEN), rayon, polyketone, carbon fiber, PBO, and glass fiber. The weft yarns 312 hold the warp yarn pairs 311 in a desired spaced apart orientation.

The weft yarns 312 may be a spun staple yarn, a multifilament yarn, and/or a monofilament yarn formed of a suitable material. Examples of suitable materials for the weft yarns 312 include polyamide, aramids (including meta and para forms), polyester, polyvinyl acetate, nylon (including nylon 6, nylon 6,6, and nylon 4,6), polyethylene naphthalate (PEN), cotton, rayon, polyketone, carbon fiber, PBO, and glass fiber.

The warp and/or weft yarns 311, 312 may also be hybrid yarns. Hybrid yarns may be multiple yarns, made up of at least 2 fibers of different material (for example, aramid and nylon). These different fiber materials may produce hybrid yarns with various chemical and physical properties. Hybrid yarns may be able to change the physical properties of the final product in which they are used. Example hybrid yarns may be an aramid fiber with a nylon fiber, an aramid fiber with a rayon fiber, and an aramid fiber with a polyester fiber.

As used herein, mechanical resiliency of a yarn is the ability of the yarn to displace longitudinally without an elastic deformation of the material. Mechanical resiliency allows the LENO fabric 310 to have a minor amount of resilient elongation for compatibility with the example tire 10, but use stronger yarns in the carcass ply 14.

The woven reinforcing structure 141 may extend radially from the axial end portions 30a, 30b of the carcass ply 14 around the beads 28a, 28b to a location 143 at the maximum section width of the pneumatic tire 10. The woven reinforcing structure 141 is an open construction fabric which permits the strike through of rubber in a tire 10 for a better bonded construction. The openness of the fabric used for the woven reinforcing structure 141 may be determined by the spacing and character of the warp yarns 311 or 511. The weft yarns 312 are typically spaced as necessary to maintain the position of the warp yarns 311 or 511 provide suitable strength to the carcass ply 14.

The woven reinforcing structure 141 may be treated with an adhesion promoter. Examples of adhesion promoters include resorcinol formaldehyde latex (RFL), isocyanate based material, epoxy based material, and materials based on melamine formaldehyde resin. The woven reinforcing structure 141 may also have a tackified finish, or green tack, applied for facilitating adhesion during the building process of a green tire. The selection of materials for the tackified finish may depend upon the materials selected for use in the tire 10. Tackified finishes may be achieved by various methods such as coating the fabric in an aqueous blend of rosin and rubber lattices, or with a solvent solution of an un-vulcanized rubber compound.

Further, the woven reinforcing structure 141 may comprise multiple layers, e.g. two, three, or even more layers, of the LENO fabric 310, 510 to provide extra strength for the bead regions 24a, 24b. When more than one layer of LENO tape 310 is used for the structure 141, a layer of unvulcanized rubber may be placed between the layers of LENO tape to ensure an effective bond.

The formation of the woven reinforcing structure 141 may begin with the acquisition of the basic yarns for the fabric. Subsequently, the yarns may be twisted to provide additional mechanical resilience. After the twisting, warp yarns 311a, 311b may be placed on a large beam for the formation of the woven reinforcing structure 141. The woven reinforcing structure 141 may be formed by LENO weaving with the appropriate spacing of the warp yarn pairs 311. After the woven reinforcing structure 141 formation, the structure may be finished with adhesive promoter, such as an RFL treatment. If a tackified finish is desired, this is provided following the adhesive promoter finishing. The final layer may be slit into the specific widths.

The woven or knitted reinforcing structure 141 in accordance with the present invention improves rolling resistance by optimizing mileage, high speed capability, and handling characteristics. Additionally, the woven reinforcing structure 141 may reduce noise due to vibration damping in the bead area (i.e., circumferential reinforcement provided by the warp yarns 311 or 511.

One example construction for the woven or knitted reinforcing structure 141 may comprise 2200/2 Dtex 26 EPI (ends per inch) polyester warp yarns and 1220/1 Dtex 14 EPI rayon weft yarns. In general, the warp pairs 311 may have a density of 5 EPI to 18 EPI and the weft may have a density of 5 EPI to 35 EPI.

The woven reinforcing structure 141 in accordance with the present invention thus reduces rolling resistance along with other tire performance characteristics being equal or better. The woven reinforcing structure 141 square woven fabric made of filament yarns of different stress-strain characteristics for warp and weft. The fabric 300, 500 may be produced with the Leno (standard or 2T) weaving technique. The warp yarns 311, 511 may be different modulus than the weft yarns 312, 512, or the same.

The fabric 310, 510 may be used as carcass reinforcement with only the bead regions 24a, 24b (below a maximum section width) reinforced with a warp material. The modulus increase in the radially inner section of the pneumatic tire 10 may thus decrease rolling resistance of a cured tire. The fabric 310, 510 may be dipped, tackified, and woven to the a specified ply width (FIG. 3). The fabric 300, 500 does not require calendering and may thus be applied directly at a tire building machine.

Further, there is now no requirement to calender the fabric 310, 510 or slit the material prior to application on a green tire. Rolls of fabric produced at specified width (ply width) may be supplied to a tire plant and directly applied on a tire building machine. The warp yarn may provide a circumferential reinforcement whereas a conventional carcass provides only a radial reinforcement. The woven or knitted reinforcing structure 141 provides additional circumferential stiffness to a carcass package in the bead area, thus reducing rolling resistance.

As stated above, a carcass ply 14 with a reinforcement structure 141 in accordance with the present invention produces excellent rolling resistance performance in a pneumatic tire 10. This carcass ply 14 thus enhances the performance of the pneumatic tire 10, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni.

A pneumatic tire has certain essential structural elements. United States Department of Transportation, Mechanics of Pneumatic Tires, pages 207-208 (1981). An important structural element is the carcass ply, typically made up of many flexible, high modulus cords of natural textile, synthetic polymer, glass fiber, or fine hard drawn steel embedded in, and bonded to, a matrix of low modulus polymeric material, usually natural or synthetic rubber. Id. at 207 through 208.

The flexible, high modulus cords are usually disposed as a single layer. Id. at 208. Tire manufacturers throughout the industry cannot agree or predict the effect of different twists of carcass ply cords on noise characteristics, handling, durability, comfort, etc. in pneumatic tires. Mechanics of Pneumatic Tires, pages 80 through 85.

These complexities are demonstrated by the below table of the interrelationships between tire performance and tire components.

| | LINER | CARCASS PLY | APEX | BELT | OV'LY | TREAD | MOLD |
|---|---|---|---|---|---|---|---|
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE COMFORT | X | X | X | | | X | |
| HIGH SPEED | | X | X | X | X | X | X |
| AIR RETENTION | X | | | | | | |
| MASS | X | X | X | X | X | X | X |

As seen in the table, carcass ply cord characteristics affect the other components of a pneumatic tire (i.e., carcass ply affects apex, belt, overlay, etc.), leading to a number of components interrelating and interacting in such a way as to affect a group of functional properties (noise, handling, durability, comfort, high speed, and mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors.

Thus, for example, when the structure (i.e., twist, cord construction, etc.) of the carcass ply cords of a pneumatic tire is modified with the intent to improve one functional property of the pneumatic tire, any number of other functional properties may be unacceptably degraded. Furthermore, the interaction between the carcass ply cords and the apex, belt, carcass, and tread may also unacceptably affect the functional properties of the pneumatic tire. A modification of the carcass ply cords may not even improve that one functional property because of these complex interrelationships.

Thus, as stated above, the complexity of the interrelationships of the multiple components makes the actual result of modification of a carcass ply, in accordance with the present invention, impossible to predict or foresee from the infinite possible results. Only through extensive experimentation have the carcass ply 14 and woven reinforcement structure 141 of the present invention been revealed as an excellent, unexpected, and unpredictable option for a tire carcass.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire having an axis of rotation, the pneumatic tire comprising:
a carcass having at least one reinforced ply and a reinforcing structure proximal to a bead region of the pneumatic tire;
a tread disposed radially outward of the carcass; and
a belt structure disposed radially between the carcass and the tread, the reinforcing structure comprising at least one layer of an open construction woven or knitted fabric having warp yarns extending in a circumferential direction and weft yarns of the carcass ply extending in a radial direction.

2. The pneumatic tire of claim 1 wherein the woven or knitted fabric has a 5 EPI to 18 EPI warp pair construction and a 5 EPI to 35 EPI weft construction.

3. The pneumatic tire of claim 2 wherein the warp yarns are 1220/1 Dtex rayon and the weft yarns are 2200/2 Dtex polyester.

4. The pneumatic tire of claim 3 wherein the warp yarns have a density of 14 EPI and the weft yarns have a density of 12 EPI.

5. The pneumatic tire of claim 1 wherein the fabric has a LENO 2T configuration with a 5 EPI to 18 EPI warp pair construction and a 5 EPI to 32 EPI weft construction.

6. The pneumatic tire of claim 1 wherein the pneumatic tire is a high performance tire.

7. The pneumatic tire of claim 1 wherein the woven or knitted fabric further comprises an adhesion promoter disposed thereon.

8. The pneumatic tire of claim 1 wherein the reinforcing structure of the carcass has one or more layers of woven or knitted fabric.

9. The pneumatic tire of claim 1 wherein weft yarns comprise at least two fibers of different fiber materials.
